(19) United States
(12) Patent Application Publication
(10) Pub. No.: US 2010/0069555 A1
(43) Pub. Date: Mar. 18, 2010

(54) MAGNESIUM HYDROXIDE, METHOD FOR PRODUCING MAGNESIUM HYDROXIDE AND A FIRE RETARDANT COMPRISING THE MAGNESIUM HYDROXIDE, AND A FIRE-RETARDED RESIN COMPOSITION CONTAINING THE MAGNESIUM HYDROXIDE

(76) Inventor: Kiyotsugu YAMASHITA, Fukaya-shi (JP)

Correspondence Address: MARSHALL, GERSTEIN & BORUN LLP, 233 SOUTH WACKER DRIVE, 6300 SEARS TOWER, CHICAGO, IL, 60606-6357, US

(21) Appl. No.: 11/816,967

(22) PCT Filed: Feb. 23, 2005
(86) PCT No.: PCT/JP2005/002914

§ 371 Date: Jul. 6, 2009

(51) Int. Cl. C01F 5/14; C08K 3/22

(52) U.S. Cl. 524/436; 423/636; 428/220

(57) ABSTRACT

Magnesium hydroxide having a large specific surface area is provided. A magnesium-containing matter is chemically decomposed by a solution of acid, and a primary solution of alkali with weak alkalinity is obtained by adding a solution of alkali to the solution of acid, and impurities contained in the primary solution of alkali are eliminated, and a secondary solution of alkali with strong alkalinity is obtained by adding a solution of alkali to the primary solution of alkali, and successively a magnesium hydroxide is deposited in secondary solution of alkali.

### TECHNICAL FIELD

The present invention relates to magnesium hydroxide having high specific surface area and a method for producing the magnesium hydroxide. Particularly, in accordance with the present invention, good reinforcing effect as well as fire retardation can be achieved by adding the magnesium hydroxide of the present invention to the resin. Furthermore, the present invention relates to a fire-retardant comprising the magnesium hydroxide, and a fire-retarded resin composition containing the magnesium hydroxide.

### BACKGROUND ART

Generally, the thermoplastic resin has good formability, good mechanical properties and electrical properties. The fire-retarded resin compositions containing fire-retardant halide such as tetra-bromo-bisphenol A, deca-brorno-diphenyloxide and the like are used in many industrial applications comprising architectural industry, electrical industries, mechanical industries, transportation industries and the like.

Particularly, since polyvinyl chloride resin composition containing fire-retardant halide has good fire retardation, the polyvinyl chloride resin is widely used as formed products such as building materials including flooring materials and coating materials electric wire, cable and the like. But, once the above formed products and coating materials burns, there is a strong possibility of serious environmental problems due to generation of poisonous gas.

In view of the foregoing, the metal hydroxide such as magnesium hydroxide, aluminum hydroxide and the like is drawing public attention by reason of environmental circumstances that dioxin is difficult to generate during incineration and poisonous gas such hydrogen halide is not generated during combustion. Since the metal hydroxide shows endothermic reaction by discharge of water due to thermal decomposition during combustion, it is contained in plastic as a fire retardant. Thermal decomposition temperature of aluminum hydroxide is from 200° C. to 350° C. and thermal decomposition temperature of magnesium hydroxide is from 340° C. to 490° C. Accordingly, magnesium hydroxide is better fire retardant than aluminum hydroxide.

The fire retardation may be controlled by specific surface area of the metal hydroxide. The fire retardation can be improved by uniform dispersion of the metal hydroxide having high specific surface area into the resin. Is about 30 m²/g the maximum of specific surface area of magnesium hydroxide which can be got now. Patent publication 1 discloses a fire retardant and method for producing thereof in which magnesium hydroxide particles having more than 30 m²/g specific surface area have been treated by specific treating agent. But, it is only stated in passage number 0039 of the patent publication 1 that 30 to 90 m²/g is preferable as specific surface area of the fire retardation. It is described in the embodiments of the patent publication 1 that the maximum of specific surface area of the fire retardant is 62 m²/g at most. Such a specific surface area of 62 m²/g makes it difficult to get a satisfactory fire retardation.

Well, the metal hydroxide such as magnesium hydroxide and or the like must be added in great quantities to the resin in order to give good fire retardation to the resin composition. On the other hand, the metal hydroxide is a hydrophilic inorganic matter having hydroxide group and poor in dispersion quality and mutual solubility to the resin of organic high molecular matter. Furthermore, if the metal hydroxide is added in large quantities to the resin in order to obtain a fire retardation, there is a possibility that good properties of the resin would be lost. In the use of magnesium hydroxide as a fire retardation, a favorable magnesium hydroxide derived from sea water, which has small quantity of impurities such as ferric matter having an effect on thermal degradation of the resin and fineness of particles diameters having an effect on other properties of the resin and appearance, is used in many cases. However, it costs a great deal for refining magnesium hydroxide derived from sea water to improve the purity of the magnesium hydroxide.

Patent publication 1
Patent provisional publication No. 2003-129056

### DISCLOSURE OF THE INVENTION

### Problems to be Solved by the Invention

In view of the foregoing, the object of the present invention is to provide a magnesium hydroxide having large specific surface area. The other object of the present invention is to provide a fire retardant having good dispersion quality to the resin. Furthermore, the another object of the present invention is to provide a method for producing magnesium hydroxide with low cost. The further another object of the present invention is to provide a fire-retarded resin composition having good fire retardation and high mechanical strength.

### Means for Solving the Problems

For attaining the object, a magnesium hydroxide of the present invention can be obtained by chemically decomposing a magnesium-containing matter by a solution of acid and successively regulating pH of the resultant matter by a solution of alkali and characterized by having specific surface area of 95 to 300 m²/g.

Furthermore, a fire retardant of the present invention is characterized by treating the magnesium hydroxide by a surface treating agent.

Furthermore, a method for producing a magnesium hydroxide of the present invention comprises chemically decomposing a magnesium-containing matter by a solution of acid and successively regulating pH of the resultant matter by a solution of alkali. The method for producing a magnesium hydroxide of the present invention is characterized by chemically decomposing a magnesium-containing matter by a solution of acid, and obtaining a primary solution of alkali with weak alkalinity by adding a solution of alkali to the solution of acid, and eliminating impurities contained in the primary solution of alkali, and obtaining a secondary solution of alkali with strong alkalinity by adding a solution of alkali to the primary solution of alkali, and successively depositing a magnesium hydroxide in the secondary solution of alkali.

Furthermore, a fire-retarded resin composition of the present invention is characterized by adding the fire retardant of 50 to 200 parts by weight to the resin of 100 parts by weight.

### EFFECTS OF THE INVENTION

Since the present invention has the above constitutions, the following effects can be achieved.

(1) A magnesium hydroxide having high specific surface area can be obtained.

(2) A fire retardant having good dispersion quality to the resin can be obtained.

(3) A method for producing magnesium hydroxide with low cost can be obtained.

(4) By adding a magnesium hydroxide of the present invention to sealing material, rubber, resin for electric wire coating material and the like, it is possible to give good fire retardation and keep high mechanical strength.

(5) Industrial use of materials such as asbestos, serpentinite containing asbestos, sepiolite, talc and the like is restricted over the world due to harmfulness of the asbestos. But, in accordance with the present invention, these materials can be chemically decomposed into non-asbestos and regenerated as a magnesium hydroxide having safety and improved function. Furthermore, the asbestos has been utilized so far as many industrial materials. Especially, in many cases, the asbestos has been used as building materials. Accordingly, the present invention is effective means for recycling an industrial waste obtained by breaking up the above building materials. Thus, the present invention can provide exceedingly effective means for utilizing limited natural resources.

### BRIEF DESCRIPTION OF DRAWINGS

FIG. 1 is a diagrammatic drawing showing an example of flow of method for producing a magnesium hydroxide in accordance with the present invention.

FIG. 2 is a diagrammatic drawing showing a flow of method for producing a magnesium hydroxide in accordance with the contrast.

### BEST MODE FOR CARRYING OUT THE INVENTION

A magnesium hydroxide of the present invention is characterized in having high specific surface area. A producing process of the present invention for obtaining the magnesium hydroxide having high specific surface area comprises processes with which the general methods are not provided. The present invention will be described in detail below.

A method for producing a magnesium hydroxide can be divided roughly into two methods of the reaction synthesis method and the natural mineral crushing method. For example, the reaction synthesis methods comprise a method of adding a slurry of caustic alkali or hydrated lime to sea water or bittern in order to react those materials, a method of adding sodium hydroxide to a slurry of magnesium hydroxide to be subjected to heating treatment (e.g. patent publication No. 50-23680), a method of heating treatment of a slurry of basic magnesium salt (e.g. patent provisional publication No. 52-115799), and a method of reacting a solution of magnesium salt with ammonia (e.g. patent provisional publication No. 61-168522), and the like. In these methods, a synthesized magnesium hydroxide is rinsed, surface-treated, dehydrated, dried and crushed to obtain a fire retardant comprising magnesium hydroxide.

The natural mineral crushing method consists of crushing natural brucite ore containing a magnesium hydroxide as main component and giving surface treatment thereof to be converted into a fire retardant comprising magnesium hydroxide. After the natural brucite ore has been converted to aqueous slurry, wet crushing is conducted. The surface treatment of slurry containing crushed materials is conducted by emulsion of an ammonium salt of fatty acid or amine salt, and a solid-liquid separation is followed by drying. An example of natural mineral crushing method comprising such processes is disclosed in patent publication 7-42461.

The magnesium hydroxide obtained by the reaction synthesis method has comparatively uniform quality and fine particle diameters. Accordingly, even if the above magnesium hydroxide is tightly filled, it is possible to keep deterioration of mechanical properties comparatively small. But, in comparison with the natural mineral crushing method, the reaction synthesis method has disadvantages in that the material cost is expensive, and manufacturing process thereof is complicated, and it needs a process of high energy cost.

The fire retardant comprising magnesium hydroxide obtained by the natural mineral crushing method is a comparatively cheap and economically good fire retardant because the natural brucite ore is cheap. But, since the fire-proof effect of the fire retardant comprising magnesium hydroxide is a little smaller than the fire retardant comprising halogen, the fire retardant comprising magnesium hydroxide must be added in large quantities to resin. In case of use of the magnesium hydroxide having small specific surface area, if the magnesium hydroxide is not added in large quantities to resin, enough fire retardation is hard to obtain. As a result, the above disadvantages are brought about.

So, in accordance with the present invention, if a magnesium-containing matter is chemically decomposed by a solution of acid and successively two stages pH regulation is conducted by adding a solution of alkali to the solution of acid, as a result of such simple process, it is possible to effectively eliminate impurities and obtain a magnesium hydroxide having remarkably higher specific surface area than general magnesium hydroxide. If the fire retardant comprising magnesium hydroxide having high specific surface area is added to the resin, the fire-retarded resin composition having good fire retardation together with high mechanical strength can be provided.

That is say, the present invention is characterized by chemically decomposing a magnesium-containing matter by a solution of acid, and obtaining a primary solution of alkali with weak alkalinity by adding a solution of alkali to the solution of acid, and eliminating impurities contained in the primary solution of alkali, and obtaining a secondary solution of alkali with strong alkalinity by adding a solution of alkali to the primary solution of alkali, and successively depositing a magnesium hydroxide in the secondary solution of alkali. Since the present invention has the first stage of eliminating impurities and the second stage of depositing a magnesium hydroxide, it is possible to effectively eliminate impurities and improve the purity of magnesium hydroxide. However, if a magnesium hydroxide has been produced by only one stage for deposition of magnesium hydroxide without the first stage of eliminating impurities, the product of magnesium hydroxide contains a great deal of impurities such as ferriferous material, aluminum, calcium and the purity of magnesium hydroxide decreases.

Magnesium-containing matters comprise asbestos, serpentine, peridotite, talc, sepiolite, attapulgite and dolomite.

Acids for chemically decomposing magnesium-containing matters comprise hydrochloric acid, sulfuric acid and nitric acid, which are not limitative. Preferably, every solution of acid contains more quantity of acid than theoretical quantity needed for dissolving all of magnesium oxide contained in the magnesium-containing matter. If an excess of acid by 10 to 20% to the theoretical quantity is added, preferably magnesium oxide can be dissolved without remains in particular.

A solution of alkali for regulating pH of a solution of acid in which magnesium-containing matters are dissolved comprise sodium hydroxide, potassium hydroxide, sodium carbonate and ammonium hydroxide, which are not limitative.

A primary solution of alkali with weak alkalinity can be obtained by adding the above solution of alkali to the solution of acid. This primary solution of alkali is filtered to remove impurities and a magnesium hydroxide having high purity can be obtained. If this impurities-removing process is not provided (only magnesium hydroxide-deposition process the product of magnesium hydroxide contains a great deal of impurities such as ferriferous material, aluminum, calcium and the purity of magnesium hydroxide decreases. For this reason, preferably pH of a primary solution of alkali is within ranging from 7.5 to 8.5.

Further, a secondary solution of alkali can be obtained by adding alkaline aqueous solution to the primary solution of alkali. For example, if the alkaline aqueous solution is gradually added to the primary solution of alkali of pH 8, pH of the solution is raising while a little magnesium hydroxide is coming into being gradually. Besides, when the alkaline solution is added continuously, arise of pH is suspended at about pH of 10.5 and a deposition of magnesium hydroxide starts. After the deposition of magnesium hydroxide has been completed, pH of the solution is rising rapidly. The reason of this phenomenon is that magnesium reacts with hydroxyl group most effectively at about pH of 10.5. Accordingly, if pH of the secondary solution of alkali is lower than 10.0, a magnesium does not react well with hydroxyl group and the generation of magnesium hydroxide takes many hours. This is not effective. On the other hand, even if pH of the secondary solution of alkali is increased more than 11.0, the reaction between magnesium and hydroxyl group is not improved and there remains an excess of solution of alkali which does not make a contribution to the reaction. This is not economical. For the above reason, preferably pH of the secondary solution of alkali is within ranging from 10.0 to 11.0.

As described above, in accordance with the present invention, it is possible to provide a magnesium hydroxide which has purity of 99% or more and specific surface area of 95 to 300 g/m².

A magnesium hydroxide having specific surface area of less than 95 m²/g cannot possess enough fire retardation. Even though a magnesium hydroxide having specific surface area of more than 300 m²/g is subjected to the surface treatment below, good dispersion to the resin cannot be obtained in some cases. In particular, preferably the specific surface area of magnesium hydroxide is 100 to 200 m²/g. In a magnesium hydroxide having specific surface area of less than 100 m²/g, enough fire retardation and reinforcement effect are hard to obtain. Even though a magnesium hydroxide having specific surface area of more than 200 m²/g is used, it is not possible to improve fire retardation and reinforcement effect further. In a case, good dispersion to the resin cannot be obtained.

In order to prevent a magnesium hydroxide from agglomerating and improve the dispersion quality of magnesium hydroxide to the resin, the magnesium hydroxide is crushed to conduct the treatment for fining, and particles of magnesium hydroxide are treated by surface treating agent, and finally a fire retardant can be obtained.

Furthermore, in order to prevent a magnesium hydroxide from agglomerating and improve the dispersion quality of magnesium hydroxide to the resin, a surface treating agent is added to a slurry of magnesium hydroxide in order to give the magnesium hydroxide wet-surface treatment, and after having been dried, the magnesium hydroxide is crushed, and finally a fire retardant can be obtained.

For example, as surface treating agent, at least one selected from group comprising silane coupling agent, higher fatty acid, higher fatty acid metallic salt, higher fatty acid ester, higher fatty acid amides, higher alcohol or hardened oil can be used. Preferably, the surface treating agent is added to magnesium hydroxide by 0.5 to 5.0% by weight. If the surface treating agent is less than 0.5% by weight, tensile elongation of the resin component decreases and flowability and formability of the mixture of resin and surface treating agent lower. If the surface treating agent is more than 5.0% by weight, fire retardation and mechanical properties lower.

The surface of magnesium hydroxide particle are coated by the surface treating agent. The word of “higher fatty acid” means that number of carbon is more than eight, and preferably thirty or less. Whether the higher fatty acid belongs to normal chain compound or branched chain compound, and the higher fatty acid is saturated or unsaturated, all of the above higher fatty acid can be used. Every surface treating agent as described above has good dispersion quality in powders and good flowability at a time of being mixed with resin, and enhanced mechanical properties of the compound.

As silane coupling agent, vinylethoxy silane, vinyltris(2-methoxy)silane, γ-methacryloxypropyl trimethoxy silane, γ-aminopropyl trimethoxy silane, γ-(3,4-epoxycyclohexyl)ethyl trimethoxy silane, γ-glusidoxypropyl trimethoxy silane, γ-mercaptopropyl trimethoxy silane and the like can be used, which are not limited. Furthermore, in addition to silane coupling agent, titanate coupling agent or aluminum coupling agent can be used.

As higher fatty acid, stearic acid, oleic acid, palmitic acid, linoleic acid, lauric acid, caprylic acid, behenic acid, montanic acid can be used, which are not limited.

As higher fatty acid metallic salt, stearate salts, oleate salts, palmitate salts, linoleate salts, laurate salts, caprylate salts, behenate salts, montanate salts can be used, which are not limited. Metal constituting part of those salts comprises sodium, potassium, aliminum, calcium, magnesium, zinc, barium and the like.

As higher fatty acid ester, methyl laurate, methyl myristate, methyl palmitate, methyl stearate, methyl oleate, methyl erucate, methyl behenate, butyl laurate, butyl stearate, isopropyl myristate, isopropyl palmitate, octyl palmitate, octylester palm fatty acid, octyl stearate, octylester tallow fatty acid, lauryl laurate, long stearyl stearate, higher alcohol ester long chain fatty acid, behenyl behenate, cetyl myristate and the like can be used, which are not limited.

As higher fatty acid amide, amide sterate, amide oleate, amide palmitate, amide linoleate, amide laurate, amide caprylate, amide behenate, amide montanate and the like can be used, which are not limited.

As higher alcohol, octyl alcohol, decyl alcohol, lauryl alcohol, myristyl alcohol, cetyl alcohol, stearyl alcohol and the like can be used, which are not limited.

As hardened oil, tallow hardened oil, castor bean hardened oil and the like can be used.

For efficiently conducting a surface treatment, preferably crushing of a magnesium hydroxide and addition of a surface treating agent are conducted at the same time. A crusher is preferably provided with heating means in order to expedite coating of the surface treating agent on the surface of magnesium hydroxide. For example, ball mill, vibrating mill and the like can be used as crusher. The above mill is preferably provided with jacket through which warm water flows or heating means such as electric heater. As crushing media, alumina ball, zirconia ball, metallic ball, metallic rod and the like are usable, which are harder than magnesium hydroxide. It is desirable that ceramic such as alumina ball and zirconia ball would be used for preventing crushing medium or casing of crusher from being wearing out and fire retardant from being colored.

The fire-retarded resin composition of the present invention can be obtained by adding uniformly the above fire retardant to the resin. The addition ratio of magnesium hydroxide to the resin depends on the use and the properties needed for the resin compound. Generally, an addition of 50 to 200 parts by weight of the above fire retardant to 100 parts by weight of the resin is preferable to obtain the fire-retarded resin composition of the present invention. For example, for obtaining the fire-retarded resin composition for general forming product such as flooring, wallpaper and face plate, it is preferable that 50 to 100 parts by weight of the above fire retardant is added to 100 parts by weight of the resin. On the other hand, for obtaining the self-fire extinguishing resin composition such as electric wire and cable coating, it is preferable that 100 to 200 parts by weight of the above fire retardant is added to 100 parts by weight of the resin. If the fire retardant of more than 200 parts by weight is added to 100 parts by weight of the resin, there is a possibility that the mechanical properties of the resin is lowered.

The resin can be selected based on the use and the requisite properties. The following resins are shown as examples:

Polyolefin resin being polymer or copolymer of olefin selected from a group of polyethylene, polypropylene, ethylene-propylene copolymer, ethylene-propylene-dienemonomer-tertiarycopolymer, ethylene-butene copolymer, ethylene-acrylate ester (ethyl acrylate) copolymer, ethylene-vinyl acetate copolymer, ethylene-methyl methacrylate copolymer and the like, polymer of aromatic vinylmonomer such as styrene or copolymer such as alkylbenzene sulfonic acid resin, polyester such as poly (metha) acrylic resin, polyethylene terephthalate, polybutylene terephthalate, polyalylate and the like, polyamide such as polyamide 6, polyamide 66, polyamide 12, polyamide 46, aromatic polyamide and the like, polyether such as polyphenylene ether, modified polyphenylene ether, polyoxymethylene and the like, elastomer such as polycarbonate, styrene coupled diene copolymer, polybutadiene, polyisoprene, acrylonitrile butadiene copolymer, polychloroprene and the like, polyvinyl chloride and the like.

The following thermosetting resins can be used; Phenolic resin, epoxy resin, unsaturated polyester resin, polyurethane resin and the like.

These resins can be used by only itself or mixing two kinds thereof or more. Since magnesium hydroxide has a large fire retardation effect, polyolefin resin is preferable.

In addition to the above fire retardant, the fire-retarded resin composition of the present invention may contain other additives, if necessary. The additives comprise plasticizer, lubricant, filler, antioxidant, thermo-stabilizer, cross-linking agent, cross-linking aid agent, antistatic agent, mutual dissolving agent, sunshine-stabilizer, pigment, blowing agent, antimold agent and the like.

Those resin composition can be obtained by mixing the requisite additives to the above fire retardant and kneading the resultant matter. The kneading means comprise uniaxial extruder, biaxial extruder, rollkneader, kneader, banbury mixer and the like. The fire-retarded resin composition of the present invention thus obtained can be suitably used for producing forming products. The forming means comprise injection molding, extrusion, blow molding, press forming, vacuum forming, calender, transfer molding and the like.

### Embodiment 1

The embodiments of the present invention will be described below. But the present invention is not limited to the embodiments. The present invention may be properly modified or revised without departing from the scope of the present invention.

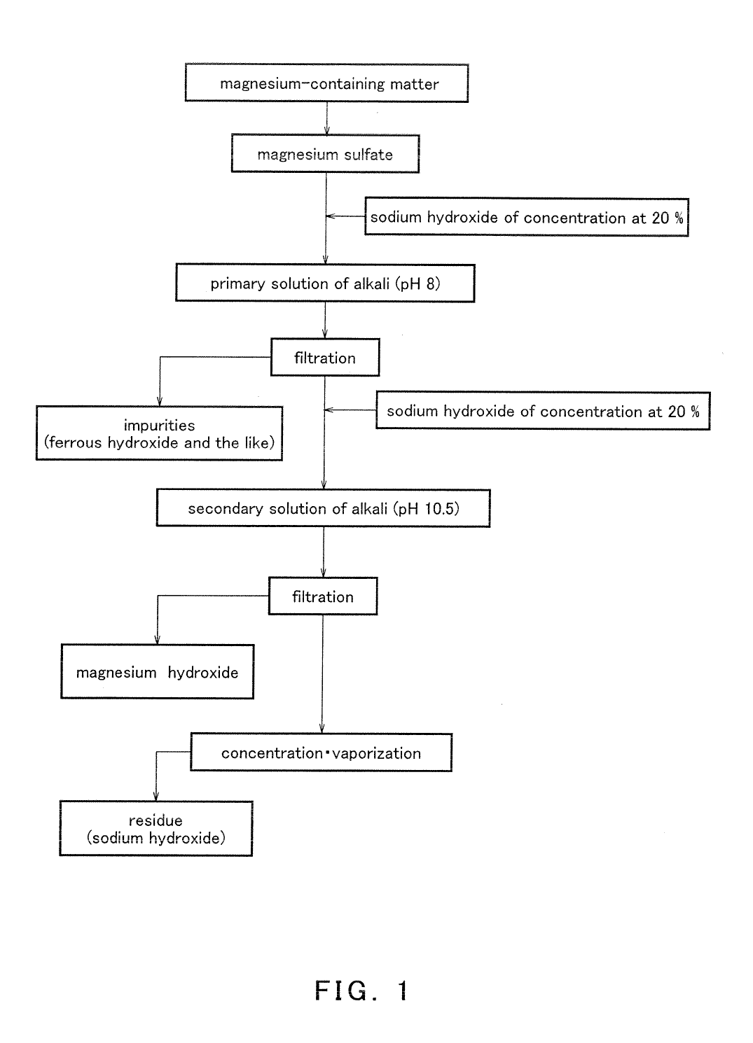

1. Production of Magnesium Hydroxide (see flowchart of FIG. 1)

(1) Chemical Decomposition of Magnesium-Containing Matter by Solution of Acid

Serpentinites were crushed and classified to obtain powders, and the powders were suspended in the water to be converted to slurry. The above powders have mean diameter of 300 μm and BET specific surface area of 8 m²/g which can pass through screen of 50 mesh size. An excess of sulfic acid by 15 percent to the theoretical value needed for dissolving all of magnesium hydroxide contained in serpentinites (i.e. sulfic acid of concentration at 98%) was added slowly to the above slurry, and stirred for two hours at the temperature of 100° C.

(2) Filtration

The above slurry was filtered to obtain magnesium sulfate.

(3) Preparation of Primary Solution of Alkali

Sodium hydroxide of concentration at 20% was added to the magnesium sulfate with a stir, and pH of the solution was regulated to be 8. As a result, since impurities (e.g. ferrous hydroxide and the like) were precipitated, the solution was filtered to remove impurities. This preparation of the primary solution of alkali is necessary for purity of the magnesium hydroxide to be increased.

(4) Preparation of Secondary Solution of Alkali

Sodium hydroxide of concentration at 20% was added to the primary solution of alkali whose containing impurities were removed with a stir, and pH of the solution was regulated to be 10.5. Under this condition, the solution was for two hours to deposit magnesium hydroxide. It is preferable to stir the solution for an hour or two at pH of 10.5 to stably grow the crystal of magnesium hydroxide.

(5) Recovery of Magnesium Hydroxide

A magnesium hydroxide was recovered by filtering the secondary solution of alkali. The magnesium hydroxide was rinsed by pure water and dried. After the magnesium hydroxide has been extracted from the secondary solution of alkali, if the remaining solution of alkali would be concentrated, sodium hydroxide may be recovered. This sodium hydroxide can be used as raw materials of industrial applications.

2. Properties of Magnesium Hydroxide

About the magnesium hydroxide of the embodiment 1 of the present invention obtained by carrying out the above processes from (1) to (5) and the magnesium hydroxide of the contrast, specific surface area and purity thereof were measured. The magnesium hydroxide of the contrastwas obtained by adding sodium hydroxide to sea water. The results were as follows: The value of specific surface area is in accordance with three points methods by BET and the value of purity is in accordance with fluorescence X-ray diffraction.

(1) The magnesium hydroxide of the embodiment 1 of the present invention

The specific surface area (m²/g) is 185, and the purity is 99.5%.

(2) The magnesium hydroxide of the contrast

The specific surface area (m²/g) is 30, and the purity is 97.0%.

(3) Comparison between the embodiment 1 of the present invention and the contrast.

The specific surface area of magnesium hydroxide of the embodiment 1 of the present invention is over six times that of magnesium hydroxide obtained by the general sea-water extraction. The purity of magnesium hydroxide of the embodiment 1 of the present invention is purer than magnesium hydroxide obtained b the general sea-water extraction.

3. Properties of Fire-Retarded Resin Composition

180 parts by weight of the magnesium hydroxide of the embodiment 1 of the present invention obtained by carrying out the above processes from (1) to (5) or the magnesium hydroxide of the contrast was added to 100 parts by weight of the resin for covering wire (ethylene-ethyl acrylate copolymer, trade name of A-1150 produced by Nippon Polyethylene Co., Inc.). Antioxidants (Hindered phenol, trade name of Irganox produced by Ciba Specialty Chemicals) of 0.5 parts by weight was added to the above resins containing the magnesium hydroxide of the present invention or the magnesium hydroxide of the contrast respectively. Those materials were formed into the test pieces having the following shape, and those test pieces were subjected to the measurement of tensile stress (MPa), ignition time (second) and mean exothermic rate (kW/m²). The test piece for the measurement of tensile stress was formed into thickness of 2 mm, length of 105 mm and width of 125 mm. The test pieces for the measurement of ignition time and mean exothermic rate were formed into thickness of 2 mm, length of 100 mm and width of 100 mm. The results are shown in Table 1.

The value of tensile stress is in accordance with JIS-K 7113. The values of ignition time and mean exothermic rate are in accordance with ISO 5560-1.

The forming condition is as follows:

After the material has been stirred for twenty minutes at temperature of 140° C. using roll mill, the material has been pressed under a pressure of 17 MPa for two minutes at temperature of 150° C.

TABLE 1

| | Embodiment 1 | Contrast |
|---|---|---|
| Component | | |
| ethylene-ethyl acrylate copolymer | 100 | 100 |
| magnesium hydroxide | 180 | 180 |
| antioxidant | 0.5 | 0.5 |
| Properties | | |
| tensile stress (MPa) | 90 | 34 |
| ignition time (second) | 87 | 65 |
| mean exothermic rate (kW/m²) | 59 | 98 |

As clearly shown in table 1, the tire-retarded resin composition containing magnesium hydroxide of the embodiment 1 of the present invention has remarkably increased tensile strength, remarkably lengthened ignition time, and remarkably shortened exothermic rate in comparison with the fire-retarded resin composition of the contrast. Thus, in accordance with the fire-retarded resin composition of the present invention, mechanical properties and fire-retardation quality can be sharply improved compared with the general fire-retarded resin composition.

### Embodiment 2

### 1. Production of Magnesium Hydroxide (See Flowchart of FIG. 1)

(1) Recovery of Asbestos

After wastes of asbestos-containing building materials (wave-shaped slate) were crushed and classified, the asbestos contained in the building materials (powders which had passed through screen having mesh of an opening of 450 μm square were recovered.

(2) Chemical Decomposition of Magnesium-Containing Matter by Solution of Acid

The powders of asbestos were suspended in the water to be converted to slurry. An excess of sulfic acid by 15 percent to the theoretical value needed for dissolving all of magnesium hydroxide contained in asbestos (i.e. sulfic acid of concentration at 98%) was added slowly to the above slurry, and stirred for two hours at the temperature of 100° C.

(3) Filtration

The above slurry was filtered to obtain magnesium sulfate.

(4) Preparation of Primary Solution of Alkali

Sodium hydroxide of concentration at 20% was added to the magnesium sulfate with a stir, and pH of the solution was regulated to be 8. As a result, since impurities (e.g. ferrous hydroxide and the like) were precipitated, the solution was filtered to remove impurities.

(5) Preparation of Secondary Solution of Alkali

Sodium hydroxide of concentration at 20% was added to the primary solution of alkali whose containing impurities were removed with a stir, and pH of the solution was regulated to be 10.5. Under this condition, the solution was for two hours to deposit magnesium hydroxide.

(6) Recovery of Magnesium Hydroxide

A magnesium hydroxide was recovered by filtering the secondary solution of alkali. The magnesium hydroxide was rinsed by pure water and dried.

### 2. Properties of Magnesium Hydroxide

About the magnesium hydroxide of the embodiment 2 of the present invention obtained by carrying out the above processes from (1) to (6) and the magnesium hydroxide of the contrast, after those materials were subjected to the dispersion treatment in water for five minutes using ultrasonic dispersion apparatus (trade name of DG2000 produced by J-TEC Co., Inc.), specific surface area and purity thereof were measured. The magnesium hydroxide of the contrast is an article on the market having specific surface area of 7 m²/g of trade name of kisuma-5A produced by Kyowa Chemical Co., Inc. The results were as follows: The value of specific surface area is in accordance with three points methods by BET and the value of purity is in accordance with fluorescence X-ray diffraction.

(1) The magnesium hydroxide of the embodiment 2 of the present invention.

The specific surface area (m²/g) is 104, and the purity is 99.6%.

(2) The magnesium hydroxide of the contrast.

The specific surface area (m²/g) is 13, and the purity is 98.5%.

(3) Comparison between the embodiment 2 of the present invention and the contrast.

The specific surface area of magnesium hydroxide of the embodiment 2 of the present invention is eight times that of magnesium hydroxide of the article on the market. The purity of magnesium hydroxide of the embodiment 2 of the present invention is purer than magnesium hydroxide of the article on the market.

### 3. Properties of Fire-Retarded Resin Composition

Stearic acid of 2.5% by weight was added to the powders of magnesium hydroxide of the embodiment 2 of the present invention obtained by carrying out the above processes from (1) to (6) prior to adding to the resin as described below, and stirred in the ethanol for ten minutes. And then, the ethanol was vaporized at temperature of 60° C. and subjected to vacuum drying. 150 parts by weight of the powders of the magnesium hydroxide of the present invention obtained as described above or the magnesium hydroxide of the contrast was added to 100 parts by weight of the resin for covering wire (ethylene vinyl acetate copolymer, trade name of NOVATEC-EVA producted by Nippon Polyethylene Co., Inc.). Antioxidants (Hindered phenol, trade name of Irganox produced by Ciba Specialty Chemicals) of 0.5 parts by weight was added to the above resins containing the magnesium hydroxide of the present invention or the magnesium hydroxide of the contrast respectively. Those materials were formed into the test pieces having the same shape by the same forming condition as embodiment 1 and those test pieces were subjected to the measurement of tensile stress (MPa), ignition time (second) and mean exothermic rate (kW/m²). The results are shown in Table 2.

The method for measuring values of tensile stress, ignition time and mean exothermic rate are the same as the embodiment 1.

TABLE 2

| | Embodiment 1 | Contrast |
|---|---|---|
| Component | | |
| ethylene-vinyl acetate copolymer | 100 | 100 |
| magnesium hydroxide | 150 | 150 |
| antioxidant | 0.5 | 0.5 |
| Properties | | |
| tensile stress (MPa) | 135 | 25 |
| ignition time (second | 98 | 55 |
| mean exothermic rate (kW/m²) | 47 | 102 |

As clearly shown in table 2, the fire-retarded resin composition containing magnesium hydroxide of the embodiment 2 of the present invention has remarkably increased tensile strength, remarkably lengthened ignition time, and remarkably shortened exothermic rate in comparison with the fire-retarded resin composition of the contrast. Thus, in accordance with the fire-retarded resin composition of the present invention, mechanical properties and fire-retardation quality can be sharply improved compared with the general fire-retarded resin composition.

Furthermore, the values of tensile stress, ignition time and exothermic rate of the embodiment 2 are improved in comparison with those of the embodiment 1. Accordingly, if the magnesium hydroxide is treated with the surface treating agent, the magnesium hydroxide is uniformly dispersed in the resin, and mechanical properties and fire-retardation can be improved.

### Embodiment 3

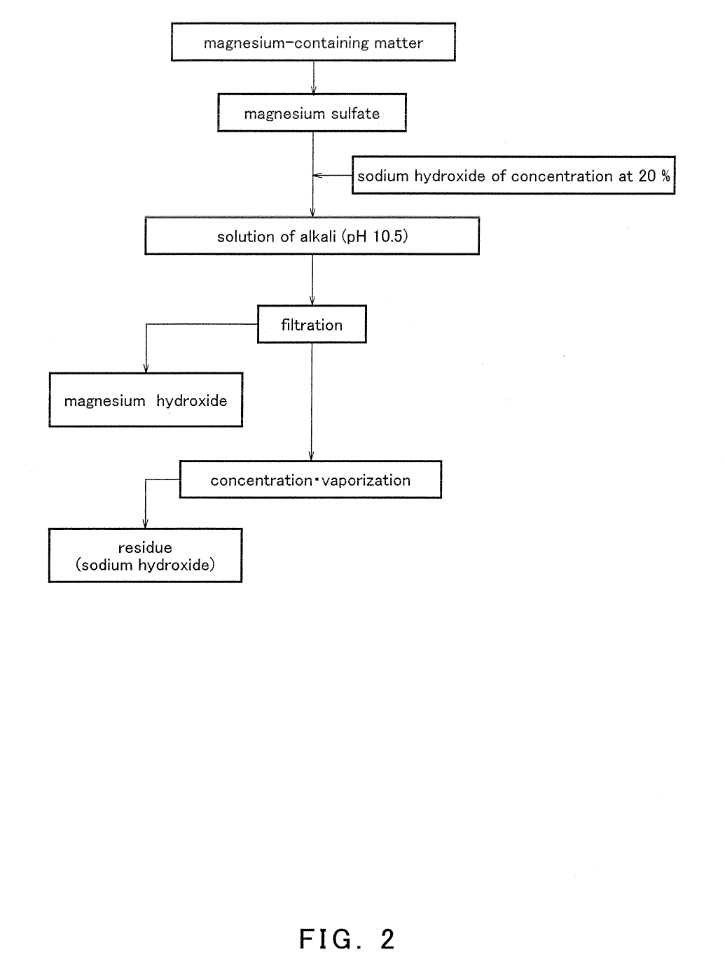

### 1. Production of Magnesium Hydroxide (See Flowcharts of FIG. 1 and FIG. 2).

The processes are the same as the embodiment 1 except that serpentinites as magnesium-containing matter were crushed and classified to obtain powders, which had passed through screen having mesh of an opening of 450 μm square. That is, magnesium hydroxide of the embodiment 3 of the present invention was obtained by the processes of embodiment 1 (see flowchart of FIG. 1) comprising chemical decomposition of magnesium-containing matter by a solution of acid, filtration of magnesium-containing slurry, preparation of a primary solution of alkali, preparation of a secondary solution of alkali and recovery of magnesium hydroxide.

In order to compare with two-stages process of the present invention, the process, which the preparation process of a primary solution of alkali was removed from the producing processes of magnesium hydroxide shown in FIG. 1, was conducted. The process of the contrast does not have impurities-eliminating process (see flowchart of FIG. 2). The process of the contrast was as follows:

Serpentinites as magnesium-containing matter were crushed and classified to obtain powders, which had passed through screen having mesh of an opening of 450 μm square. In accordance with the same processes as the embodiment 1, chemical decomposition of a magnesium-containing matter by a solution of acid and filtration of a magnesium-containing slurry were conducted. Sodium hydroxide of concentration at 20% was added to the magnesium sulfate obtained after filtration of the magnesium-containing slurry with a stir, and pH of the solution was regulated to be 10.5. Under this condition, the solution was for two hours to deposit a magnesium hydroxide. A magnesium hydroxide was recovered by filtering the solution of alkali containing magnesium hydroxide. The magnesium hydroxide was rinsed by pure water and dried. As a result, magnesium hydroxide of the contrast was obtained.

### 2. Properties of Magnesium Hydroxide

About the magnesium hydroxide of the embodiment 3 of the present invention obtained by carrying out the above processes and the magnesium hydroxide of the contrast, specific surface area and purity thereof were measured. The results were as follows: The value of specific surface area is in accordance with three points methods by BET and the value of purity is in accordance with fluorescence X-ray diffraction.

(1) The magnesium hydroxide of the embodiment 3 of the present invention.

The specific surface area (m²/g) is 105, and the purity is 99.2%.

(2) The magnesium hydroxide of the contrast.

The specific surface area (m²/g) is 102, and the purity is 85.4%.

(3) Comparison between the embodiment 3 of the present invention and the contrast.

The purity of magnesium hydroxide of the embodiment 3 of the present invention is higher than the contrast. The reason is that impurities is not removed from the magnesium hydroxide of the contrast.

### INDUSTRIAL APPLICABILITY

In accordance with the present invention, asbestos, asbestos-containing mineral or asbestos separated from asbestos-containing industrial products can be used as magnesium-containing matter. Accordingly, it is possible to regenerate asbestos-containing matter as highly value-added industrial product.

1. Magnesium hydroxide obtained by chemically decomposing a magnesium-containing matter by a solution of acid and successively regulating pH of the resultant matter by a solution of alkali, wherein the specific surface area of magnesium hydroxide is within ranging from 95 to 300 m²/g.

2. The magnesium hydroxide of claim 1, wherein the magnesium-containing matter is obtained by crushing and classifying asbestos-containing products.

3. Fire retardant obtained by treating the magnesium hydroxide of claim 1 by a surface treating agent.

4. Method for producing a magnesium hydroxide comprising chemically decomposing a magnesium-containing matter by a solution of acid and successively regulating pH of the resultant matter by a solution of alkali, wherein a magnesium-containing matter is chemically decomposed by a solution of acid, and a primary solution of alkali with weak alkalinity is obtained by adding a solution of alkali to the solution of acid, and impurities contained in the primary solution of alkali are eliminated, and a secondary solution of alkali with strong, alkalinity is obtained by adding a solution of alkali to the primary solution of alkali, and successively a magnesium hydroxide is deposited in the secondary solution of alkali.

5. The method for producing magnesium hydroxide of claim 4, wherein pH of the primary solution of alkali is within ranging from 7.5 to 8.5, and pH of the secondary solution of alkali is within ranging from 10.0 to 11.0.

6. The method for producing magnesium hydroxide of claim 4, wherein the magnesium-containing matter is obtained by crushing and classifying asbestos-containing products.

7. Fire-Retarded Resin Composition obtained by adding the fire retardant of claim 3 of 50 to 200 parts by weight to the resin of 100 parts by weight.

8. The fire-Retarded Resin Composition of claim 7, wherein the resin is polyolefin.
